(19) United States
(12) Patent Application Publication
(10) Pub. No.: US 2012/0049698 A1
(43) Pub. Date: Mar. 1, 2012

(54) BLDC Motor with Dual Rotation Directions

(76) Inventors: Alex Horng, Kaohsiung (TW); Kuan-Yin Hou, Kaohsiung (TW); Chung-Ken Cheng, Kaohsiung (TW); Chi-Hung Kuo, Kaohsiung (TW); Chih-Hao Chung, Kaohsiung (TW)

(21) Appl. No.: 12/939,237

(22) Filed: Nov. 4, 2010

(30) Foreign Application Priority Data
Aug. 24, 2010 (TW) 099128266

(51) Int. Cl. H02K 11/00

(52) U.S. Cl. 310/68 B

(57) ABSTRACT

A BLDC motor with dual rotation directions includes a rotor and a stator. The rotor has a rotating portion and a magnet portion, wherein the magnet portion has a plurality of magnetic poles each having a magnetic pole face. The stator has an excitation assembly and a control assembly. The rotating portion of the rotor is rotatably coupled with the stator. The excitation assembly has at least one excitation face and at least one coil. The control assembly is coupled to the at least one coil and has two sensors adjacent to the magnet portion. A distance exists between the two sensors on a rotational path of the magnet portion.

### BACKGROUND OF THE INVENTION

1. Field of the Invention

The present invention generally relates to a brushless direct current (BLDC) motor and, more particularly, to a BLDC motor with dual rotation directions including forward and reverse rotations.

2. Description of the Related Art

U.S. Pat. No. 7,348,740 discloses a motor control circuit for a single-phased DC motor with dual rotation directions, which includes a Hall IC, a switching circuit, a driving IC and a motor coil winding. The Hall IC detects magnetic fields generated by a rotor of the motor and generates a first signal and a second signal. The switching circuit controls the manner in which the first and second signals are input to the first and second pins of the driving IC, based on a voltage level of a contact. The driving IC generates a forward or reverse rotation signal based on the manner the pins of the driving IC receive the first and second signals, namely, based on whether the first pin receives the first signal and the second pin receives the second signal, or the first pin receives the second signal and the second pin receives the first signal. The motor coil winding is electrically connected to the driving IC to receive the forward or reverse rotation signal so as to drive the motor to rotate in the forward or reverse direction.

For the single-phased DC motor with dual rotation directions, a user may adjust the voltage level of the contact based on needs. Based on different voltage levels of the contact, the driving IC may output different driving signals to the motor coil winding to switch the rotation direction of the rotor of the single-phased DC motor. However, the single-phased DC motor performs an open-looped control based on the user's needs only, and it is difficult to detect whether the rotor genuinely rotates in the forward or reverse direction according to the user's requirement. As a result, the single-phased DC motor could rotate in the wrong direction without any self-detecting mechanism for immediate correction of the error.

Taiwanese Patent No M368229 discloses a single-phased DC motor with forward/reverse rotation, which includes a stator, a rotor, a Hall element and an excitation positioning coil. The stator includes a coil unit with a single-phased winding and a plurality of magnetic poles. The rotor includes a plurality of magnetic portions facing the magnetic poles of the stator. The Hall element is disposed at a location between two adjacent magnetic poles of the stator, and adjacent to the magnetic portions of the rotor. The excitation positioning coil can receive a first current or a second current to generate an N magnetism or an S magnetism, allowing the rotor to be positioned at an initial position where easy start of the motor is provided. Therefore, a user may use the excitation positioning coil to position the rotor in advance at the proper initial position before the stator drives the rotor to rotate.

Although the single-phased DC motor is able to achieve easy start by positioning the rotor at the proper initial position through use of the excitation positioning coil, the structure only allows control of the rotation direction of the rotor in an open-looped manner. In other words, after the rotor starts rotating, the single-phased DC motor is still not able to detect whether the rotor rotates in the forward or reverse direction as desired. Once the rotor rotates in the wrong direction, it will not be possible to stop the rotor in time. Therefore, it is desired to improve the single-phased DC motor.

### SUMMARY OF THE INVENTION

It is therefore the primary objective of this invention to provide a BLDC motor with dual rotation directions which is able to drive a rotor thereof to rotate in a predetermined direction when the BLDC motor is initialized.

It is the other objective of this invention to provide a BLDC motor with dual rotation directions which can precisely detect the rotation direction of a rotor thereof for immediate error detection.

The invention discloses a BLDC motor with dual rotation directions, which includes a rotor and a stator. The rotor has a rotating portion and a magnet portion, wherein the magnet portion has a plurality of magnetic poles each having a magnetic pole face. The stator has an excitation assembly and a control assembly. The rotating portion of the rotor is rotatably coupled with the stator. The excitation assembly has at least one excitation face and at least one coil. The control assembly is coupled to the at least one coil and has two sensors adjacent to the magnet portion. A distance exists between the two sensors on a rotational path of the magnet portion.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 shows an exploded view of a BLDC motor with dual rotation directions according to a first embodiment of the invention.

FIG. 2 shows a side cross-sectional view of the BLDC motor with dual rotation directions according to the first embodiment of the invention.

FIG. 3 shows a circuit diagram of a control assembly when the BLDC motor of the first embodiment of the invention is implemented as a single-phased motor.

FIG. 4 shows a circuit diagram of a control assembly when the BLDC motor of the first embodiment of the invention is implemented as a double-phased motor.

FIG. 5a shows voltage waveforms of a first detection signal and a second detection signal generated during clockwise rotation of the BLDC motor of the first embodiment of the invention.

FIG. 5b shows voltage waveforms of a first detection signal and a second detection signal generated during counterclockwise rotation of the BLDC motor of the first embodiment of the invention.

FIG. 6 shows an exploded view of a BLDC motor with dual rotation directions according to a second embodiment of the invention.

FIG. 7 shows a side cross-sectional view of the BLDC motor with dual rotation directions according to the second embodiment of the invention.

FIG. 8 shows an exploded view of a BLDC motor with dual rotation directions according to the other implementation of the second embodiment of the invention.

In the various figures of the drawings, the same numerals designate the same or similar parts. Furthermore, when the term “first”, “second”, “third”, “fourth”, “inner”, “outer” “top”, “bottom” and similar terms are used hereinafter, it should be understood that these terms refer only to the structure shown in the drawings as it would appear to a person viewing the drawings and are utilized only to facilitate describing the invention.

### DETAILED DESCRIPTION OF THE INVENTION

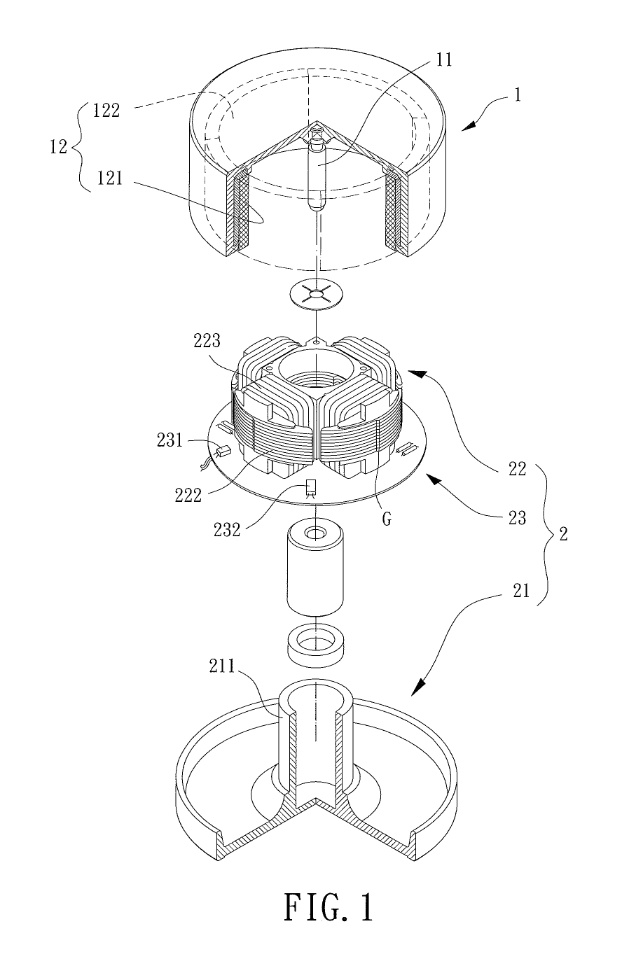

Referring to FIG. 1, an exploded view of a BLDC motor with dual rotation directions is disclosed according to a first embodiment of the invention. The BLDC motor is implemented as an outer-rotor-type motor with radial air gap in the embodiment, but is not limited thereto. The BLDC motor includes a rotor 1 and a stator 2. The rotor 1 is rotatably coupled with the stator 2 and may be driven to rotate by magnetic forces generated by the stator 2.

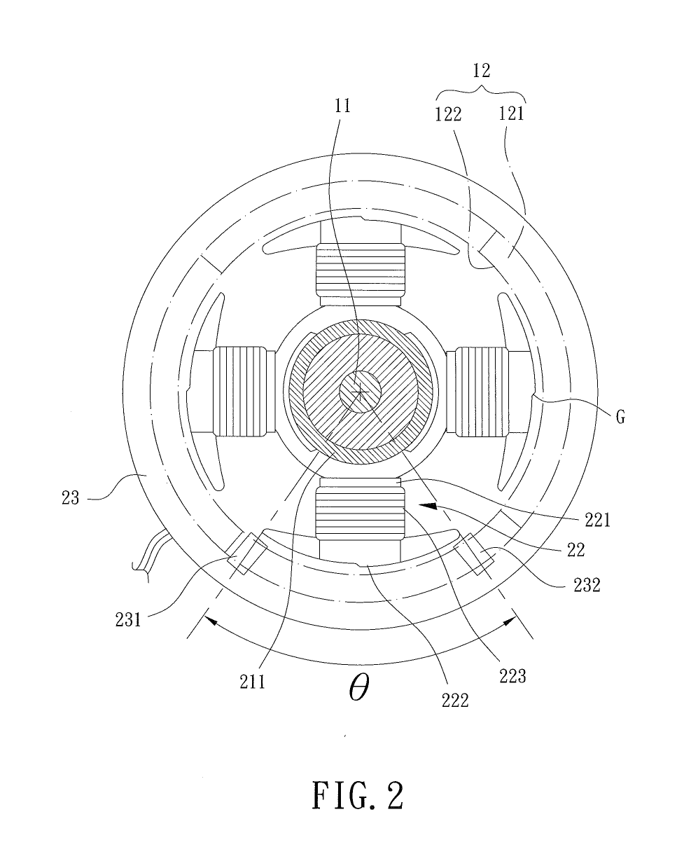

Specifically, referring to FIGS. 1 and 2, the rotor 1 of the BLDC motor includes a rotating portion 11 and a magnet portion 12. The rotating portion 11 is rotatably coupled with the stator 2 and is located at a center of the rotor 1. The rotating portion 11 is preferably in the form of a shaft as shown in FIG. 1. The magnet portion 12 is disposed around the rotating portion 11. The magnet portion 12 includes a plurality of magnetic poles 121 each having a magnetic pole face 122 facing the stator 2. Based on this, the magnet portion 12 rotates in a direction when the rotor 1 is driven.

The stator 2 includes a base 21, an excitation assembly 22 and a control assembly 23. The excitation assembly 22 and the control assembly 23 are coupled and fixed to the base 21. The base 21 includes an engaging seat 211 rotatably coupled with the rotating portion 11 of the rotor 1, with the engaging seat 211 preferably consisting of a shaft tube having a bearing disposed therein to couple with the rotating portion 11 of the rotor 1. The excitation assembly 22 includes a plurality of salient-poles 221, a plurality of excitation faces 222 and at least one coil 223. Each excitation face 222 is located on one end of a respective salient-pole 221 and faces the magnet portion 12. The coil 223 is wound around the salient-poles 221 and is adjacent to the excitation faces 222 in order for the excitation faces 222 to generate magnetic fields when the coil 223 is electrified. The control assembly 23 is disposed adjacent to the excitation assembly 22 and electrically connected to the coil 223. The control assembly 23 includes a first sensor 231 and a second sensor 232 adjacent to the magnet portion 12 of the rotor 1, with the first sensor 231 and the second sensor 232 being spaced from each other by a distance along a rotational path of the magnet portion 12. Wherein, an angle difference between two electrical angles of the first sensor 231 and the second sensor 232 is not equal to a multiple of 180 degree. In other words, an included angle defined by the first sensor 231 and the second sensor 232 is not equal to an included angle defined by a single magnetic pole 121. For example, as shown in FIG. 2, if the magnet portion 12 has four the magnetic poles 121 (which means each magnetic pole 121 has a mechanical angle of 90 degrees), then an included angle θ constructed by the first sensor 231 and the second sensor 232 is not equal to a multiple of 90 degree. In addition, as shown in FIG. 2, the first sensor 231 and the second sensor 232 are preferably located on two ends of a same excitation face 222. The excitation face 222 preferably has an unfixed distance to the magnet portion 12. For example, the excitation face 222 may have a ladder G which provides an unfixed distance between the excitation face 222 and the magnet portion 12. Alternatively, the excitation face 222 may have an increasing distance to the magnet portion 12. Based on this, each excitation face 222 will have an unfixed distance to the magnet portion 12 on two ends thereof. Thus, the magnet portion 12 is allowed to position at a predetermined position when the rotor 1 stops rotating, avoiding the first sensor 231 and the second sensor 232 to position at a dead angle where two adjacent magnetic poles 121 are joined. Thus, difficulty in starting the BLDC motor may be avoided.

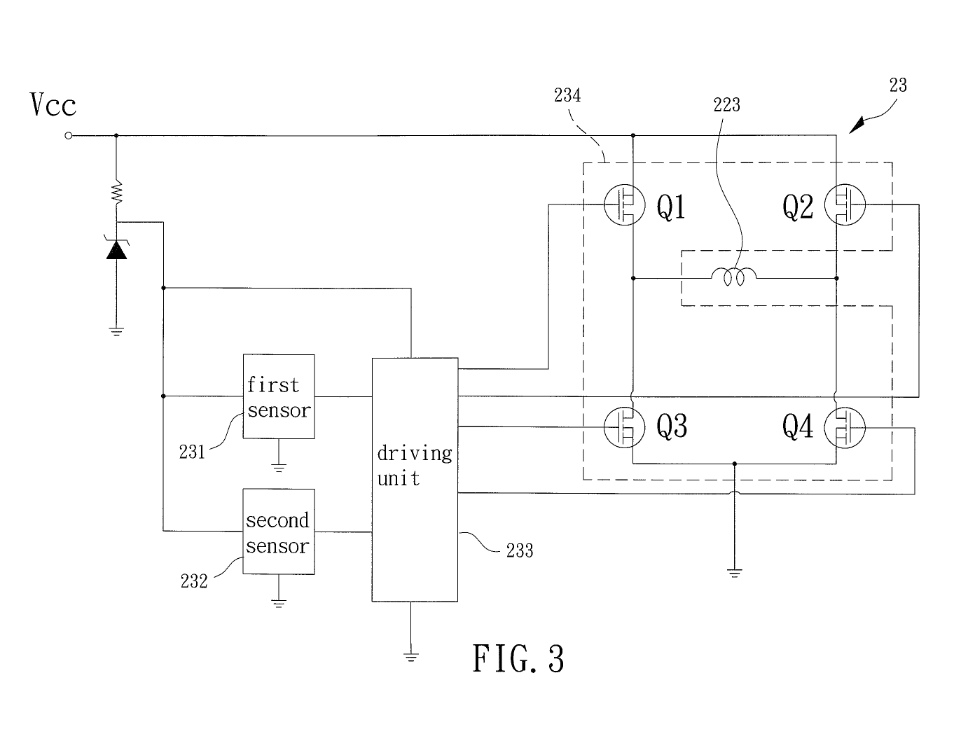

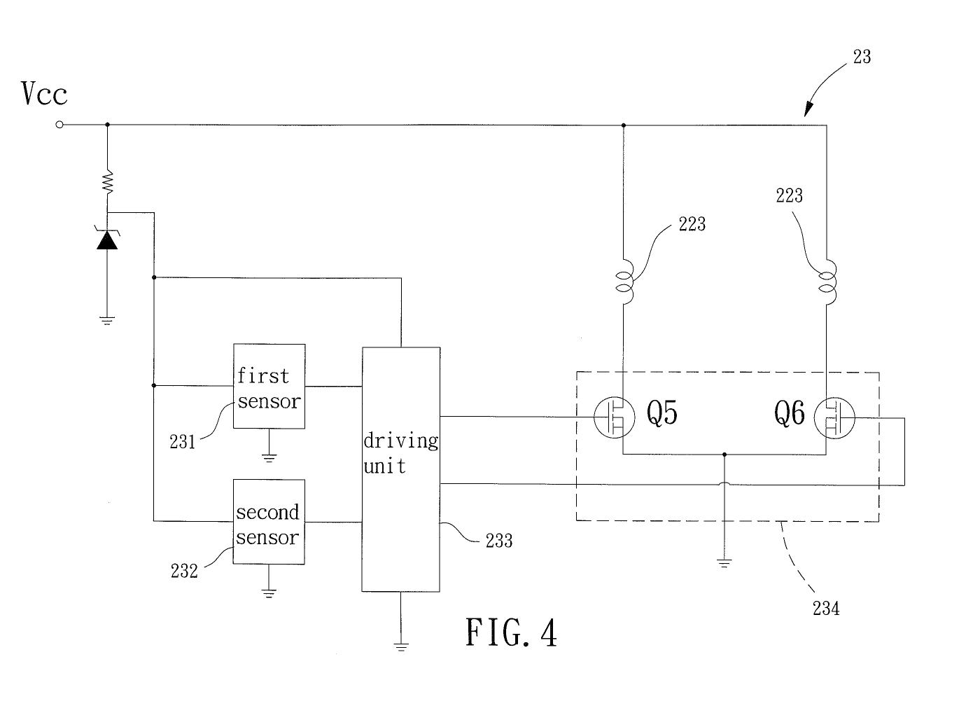

Referring to FIGS. 3 and 4, a circuit diagram of the control assembly 23 of the BLDC motor is shown according to the first embodiment of the invention. The control assembly 23 further includes a driving unit 233 and a switching module 234. The first sensor 231 and the second sensor 232 are both connected to a direct current (DC) power supply Vcc. In addition, both the first sensor 231 and the second sensor 232 can detect magnetic fields and generate a first detection signal S1 (by the first sensor 231) and a second detection signal S2 (by the second sensor 232). The driving unit 233 is electrically connected to the first sensor 231 and the second sensor 232 to receive the first detection signal 51 and the second detection signal S2. Based on the received first detection signal S1 and the second detection signal S2, the driving unit 233 generates and outputs driving signals to the switching module 234. The switching module 234 is electrically connected between the driving unit 233 and the coil 223 of the excitation assembly 22 to receive the driving signals and to generate at least an excitation current on the coil 223.

Specifically, as shown in FIG. 3, if the BLDC motor of the invention is implemented as a single-phased DC motor, the switching module 234 preferably consists of four electronic switches Q1, Q2, Q3 and Q4. Each of the electronic switches Q1, Q2, Q3 and Q4 has a control end connected to the driving unit 233 to receive one of the driving signals therefrom. The electronic switches Q1 and Q3 are connected in series between the power supply Vcc and a ground, with a node where the electronic switches Q1 and Q3 are connected together being a first node. Similarly, the electronic switches Q2 and Q4 are connected in series between the power supply Vcc and the ground, with a node where the electronic switches Q2 and Q4 are connected together being a second node. The coil 223 is connected between the first and second nodes. Referring to FIG. 2, when the magnet portion 12 of the rotor 1 rotates in a clockwise direction, the driving unit 233 generates the driving signals based on the first detection signal S1 of the first sensor 231 (i.e. the sensor that is located on a farther position along the rotational path of the rotor 1, which is the first sensor 231 in the case of clockwise rotational direction). Table 1 below shows the relationship between the first detection signal S1 and the electronic switches Q1, Q2, Q3 and Q4 based on the driving signals:

TABLE 1

| S1 | 1 | 0 |
|---|---|---|
| Q1 | ON | OFF |
| Q2 | OFF | ON |
| Q3 | OFF | ON |
| Q4 | ON | OFF |

In the above Table, when the first detection signal S1 is a high-level signal (such as logic “1” in Table 1), it means that the first sensor 231 detects magnetic fields generated by one of the N and S poles. In an opposite case, when the first detection signal S1 is a low-level signal (such as logic “0” in Table 1), it means that the first sensor 231 detects magnetic fields generated by the other one of the N and S poles.

On the contrary, when the magnet portion 12 of the rotor 1 rotates in a counterclockwise direction, the driving unit 233 generates the driving signals based on the second detection signal S2 of the second sensor 232. Table 2 below shows the relationship between the second detection signal S2 and the electronic switches Q1, Q2, Q3 and Q4 based on the driving signals:

TABLE 2

| S2 | 1 | 0 |
|---|---|---|
| Q1 | ON | OFF |
| Q2 | OFF | ON |
| Q3 | OFF | ON |
| Q4 | ON | OFF |

Similarly, when the second detection signal S2 is a high-level signal (such as logic “1” in Table 2), it means that the second sensor 232 detects magnetic fields generated by one of the N and S poles. In an opposite case, when the second detection signal S2 is a low-level signal (such as logic “0” in Table 1), it means that the second sensor 232 detects magnetic fields generated by the other one of the N and S poles.

Referring to FIG. 4, if the BLDC motor of the invention is implemented as a double-phased DC motor, the switching module 234 preferably consists of two electronic switches Q5 and Q6. Both the electronic switches Q5 and Q6 have a control end connected to the driving unit 233 to receive one of the driving signals therefrom. Each of the electronic switches Q5 and Q6 is connected to one coil 223 in series between the power supply Vcc and the ground. Referring to FIG. 2, when the magnet portion 12 of the rotor 1 rotates in the clockwise direction, the driving unit 233 generates the driving signals based on the first detection signal S1 of the first sensor 231. Table 3 below shows the relationship between the first detection signal S1 and the electronic switches Q5 and Q6 based on the driving signals:

TABLE 3

| S1 | 1 | 0 |
|---|---|---|
| Q5 | OFF | ON |
| Q6 | ON | OFF |

On the contrary, when the magnet portion 12 of the rotor 1 rotates in the counterclockwise direction, the driving unit 233 generates the driving signals based on the second detection signal S2 of the second sensor 232. Table 4 below shows the relationship between the second detection signal S2 and the electronic switches Q5 and Q6 based on the driving signals:

TABLE 4

| S2 | 1 | 0 |
|---|---|---|
| Q5 | OFF | ON |
| Q6 | ON | OFF |

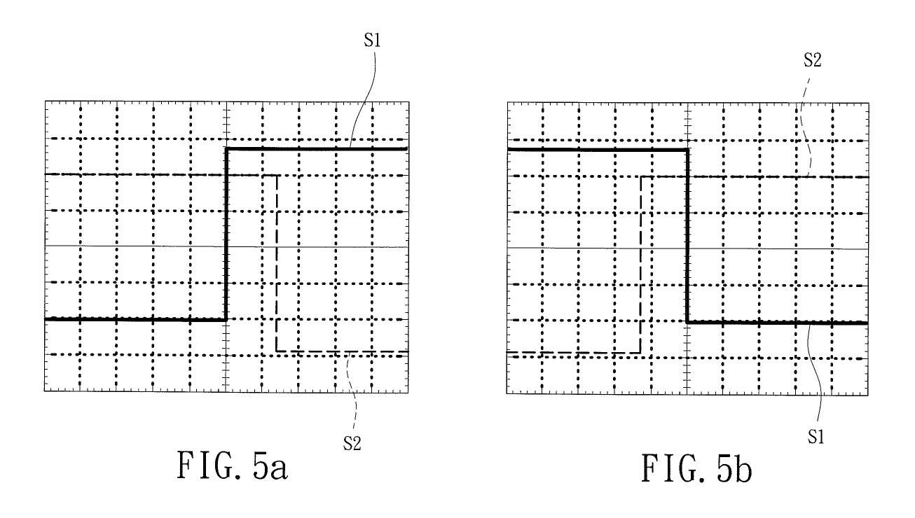

Referring to FIGS. 5a and 5b, voltage waveforms of the first detection signal S1 and the second detection signal S2, generated during forward and reverse rotations of the rotor 1, are shown. As shown in FIGS. 2 and 5a, assume that the magnet portion 12 rotates in the clockwise direction; in this case, when a left end of one magnetic pole 121 of the magnet portion 12 passes through the first sensor 231 (meaning that the first sensor 231 has entered the range of the magnetic pole 121), the first detection signal S1 will switch from the low-level signal to the high-level signal. Then, when a right end of the magnetic pole 121 passes through the second sensor 232 as the magnet portion 12 keeps rotating (meaning that the second sensor 232 has left the range of the magnetic pole 121), the second detection signal S2 will switch from the high-level signal to the low-level signal. On the contrary, as shown in FIGS. 2 and 5b, assume the magnet portion 12 rotates in the counterclockwise direction; in this case, when a right end of one magnetic pole 121 of the magnet portion 12 passes through the second sensor 232 (meaning that the second sensor 232 has entered the range of the magnetic pole 121), the second detection signal S2 will switch from the low-level signal to the high-level signal. Then, when a left end of the magnetic pole 121 passes through the first sensor 231 as the magnet portion 12 keeps rotating (meaning that the first sensor 231 has left the range of the magnetic pole 121), the first detection signal S1 will switch from the high-level signal to the low-level signal. Therefore, based on the high-level signal and the low-level signal of the first detection signal S1 and the second detection signal S2, as well as the switching timing of the first detection signal S1 and the second detection signal S2, the driving unit 233 is able to precisely detect whether the magnet portion 12 rotates in the clockwise or counterclockwise direction. Thus, when the double-phased DC motor of the invention does not rotate in a scheduled direction, the driving unit 233 may correct the rotation direction of the double-phased DC motor. For example, the driving unit 233 may stop the rotation of the double-phased DC motor and then further reset it to change its rotation direction.

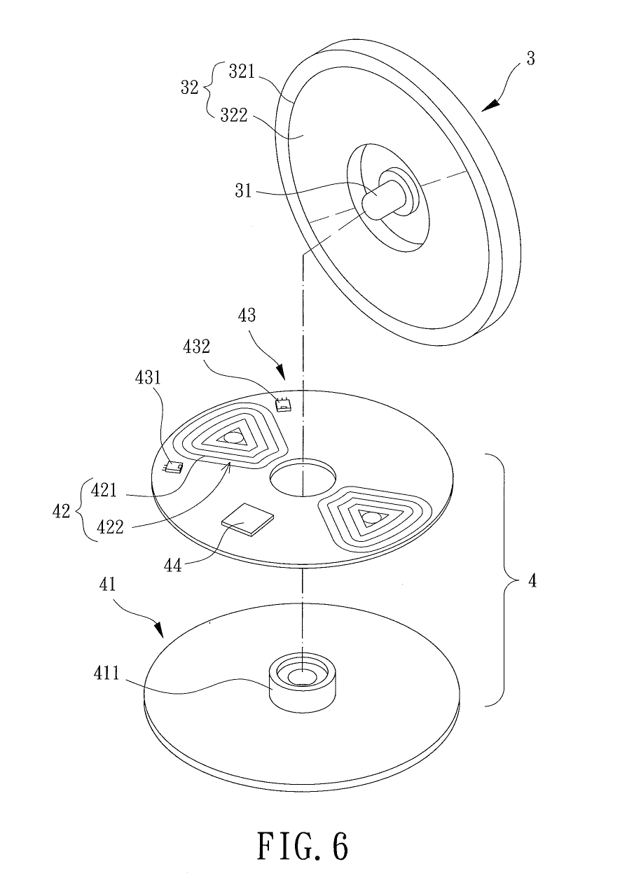

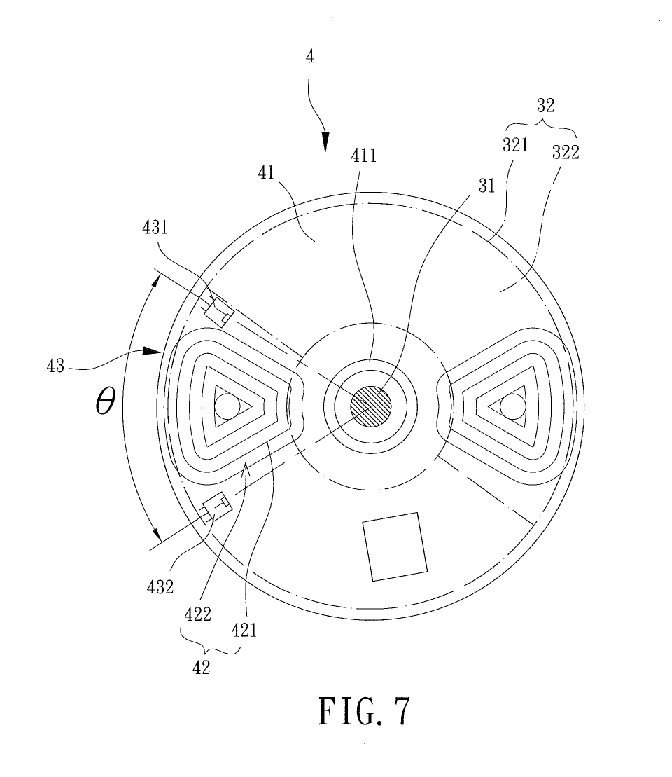

Referring to FIG. 6, an exploded view of a BLDC motor with dual rotation directions is disclosed according to a second embodiment of the invention. The BLDC motor has axial air gap in the embodiment and includes a rotor 3 and a stator 4. The rotor 3 is rotatably coupled with the stator 4 and may be driven to rotate by magnetic forces generated by the stator 4. Specifically, referring to FIGS. 6 and 7, the BLDC motor in the embodiment also includes a rotating portion 31 and a magnet portion 32. The rotating portion 31 is rotatably coupled with the stator 4 and is located at a center of the rotor 3. The rotating portion 31 is preferably in the form of a shaft and the magnet portion 32 is disposed around the rotating portion 31. The magnet portion 32 includes a plurality of magnetic poles 321 each having a magnetic pole face 322 facing the stator 4. Based on this, the magnet portion 32 rotates in a direction when the rotor 3 is driven.

The stator 4 includes a base 41, an excitation assembly 42 and a control assembly 43. The excitation assembly 42 and the control assembly 43 are coupled and fixed to the base 41. The base 41 includes an engaging seat 411 rotatably coupled with the rotating portion 31 of the rotor 3, with the engaging seat 411 resembling a shaft tube for coupling with the rotating portion 31 of the rotor 3. The excitation assembly 42 includes a plurality of coils 421 and a plurality of excitation faces 422. Each excitation face 422 abuts against a face, which faces the magnetic pole face 322, of a respective coil 421. The control assembly 43 is electrically connected to the coils 421 of the excitation assembly 42. The control assembly 43 includes a first sensor 431 and a second sensor 432 adjacent to the magnet portion 32 of the rotor 3, with the first sensor 431 and the second sensor 432 being spaced from each other by a distance along the rotational path of the magnet portion 32. Wherein, an angle difference between two electrical angles of the first sensor 431 and the second sensor 432 is not equal to a multiple of 180 degree. In other words, as shown in FIG. 7, if the magnet portion 32 has two the magnetic poles 321 (which means each magnetic pole 321 has a mechanical angle of 180 degrees), then an included angle θ constructed by the first sensor 431 and the second sensor 432 is not equal to a multiple of 180 degree. In addition, as shown in FIG. 7, the first sensor 431 and the second sensor 432 are preferably located on two ends of a same excitation face 422. Moreover, the stator 4 may further include a positioning member 44 with magnetic conductivity in order to position the magnet portion 32 at a predetermined position when the rotor 3 stops rotating. This prevents the first sensor 431 and the second sensor 432 from being located at dead angles where two adjacent magnetic poles 321 are joined.

Based on the above structure, the BLDC motor in the second embodiment can precisely control the rotation of the rotor 3 and determine whether the rotor 3 rotates in a scheduled direction. In addition, the BLDC motor also achieves smaller axial height for miniature design.

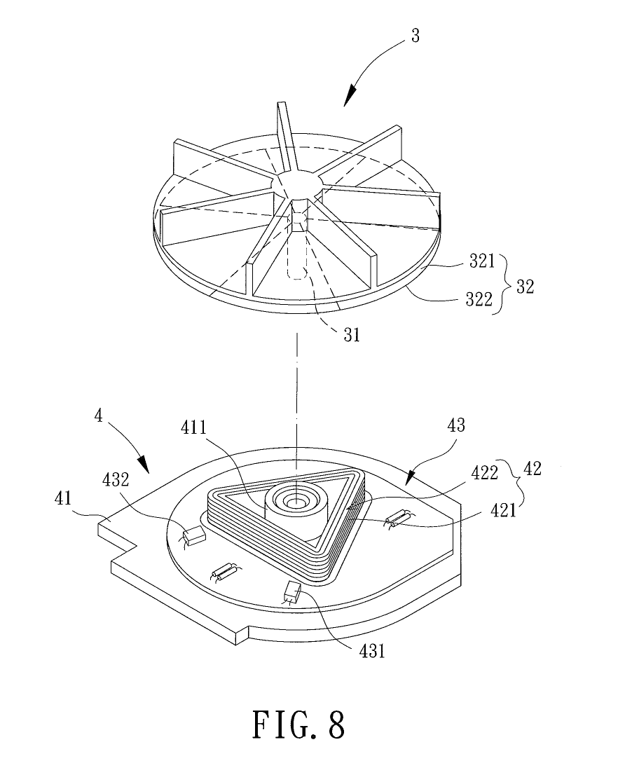

Referring to FIG. 8, the other implementation of the BLDC motor of the second embodiment of the invention is shown. In comparison with the previous embodiment, the excitation assembly 42 only includes one coil 421 and one excitation face 422, with the excitation face 422 abutting against a face, which faces the magnetic pole face 322 of the magnet portion 32, of the coil 421. In addition, the first sensor 431 and the second sensor 432 of the control assembly 43 are also adjacent to the magnet portion 32 of the rotor 3, with the first sensor 431 and the second sensor 432 being spaced from each other by the distance along the rotational path of the magnet portion 32. Thus, the BLDC motor with dual rotation directions is suitable to be applied to motors with a single coil and a single excitation face.

Although the invention has been described in detail with reference to its presently preferable embodiment, it will be understood by one of ordinary skill in the art that various modifications can be made without departing from the spirit and the scope of the invention, as set forth in the appended claims.

What is claimed is:

1. A BLDC motor with dual rotation directions, comprising:
a rotor having a rotating portion and a magnet portion, wherein the magnet portion has a plurality of magnetic poles each having a magnetic pole face; and
a stator having an excitation assembly and a control assembly, wherein the rotating portion of the rotor is rotatably coupled with the stator, the excitation assembly has at least one excitation face and at least one coil, the control assembly is coupled to the at least one coil and has two sensors adjacent to the magnet portion, and a distance exists between the two sensors on a rotational path of the magnet portion.

2. The BLDC motor with dual rotation directions as claimed in claim 1, wherein an included angle defined by the two sensors is not equal to an included angle defined by two ends of a single one of the magnetic poles.

3. The BLDC motor with dual rotation directions as claimed in claim 1, wherein the two sensors are located on two ends of a same one of the at least one excitation face.

4. The BLDC motor with dual rotation directions as claimed in claim 1, wherein the at least one excitation face includes a plurality of excitation faces and the at least one coil includes a plurality of coils, the excitation faces are perpendicular to an axial direction of the coils, and each of the excitation faces abuts against a face of a respective one of the coils that faces the magnetic pole face.

5. The BLDC motor with dual rotation directions as claimed in claim 1, wherein the stator further includes a positioning member with magnetic conductivity that is adjacent to the magnet portion of the rotor.

6. The BLDC motor with dual rotation directions as claimed in claim 1, wherein the at least one excitation face has an unfixed distance to the magnet portion.

7. The BLDC motor with dual rotation directions as claimed in claim 1, wherein the control assembly further includes a driving unit and a switching module, the driving unit is coupled to the two sensors, the switching module is coupled between the driving unit and the at least one coil of the excitation assembly, the driving unit receives two detection signals of the two sensors and generates driving signals, and the switching module receives the driving signals and generates at least one excitation current on the at least one coil.
